(19) United States
(12) Patent Application Publication
(10) Pub. No.: US 2014/0321253 A1
(43) Pub. Date: Oct. 30, 2014

(54) TEST DEVICE AND TESTING METHOD FOR TESTING FOCUS FUNCTION OF EXTERNAL DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: XIAO-LI WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/057,648

(22) Filed: Oct. 18, 2013

(30) Foreign Application Priority Data
Apr. 29, 2013 (CN) 2013101555192

(51) Int. Cl. G11B 27/36

(52) U.S. Cl. CPC G11B 27/36
USPC 369/53.28

(57) ABSTRACT

A test device communicates with an external device with a plurality of parameters. The test device includes a setting module, a first determining module, a focus module, and a prompting module. The setting module generates a setting signal for controlling the external device to set values of the parameters. The first determining module controls the focus module to generate a focus instruction to control the external device to execute a focus function, when the test device receives feedback information from the external device, which are generated by the external device after the values of the parameters are completely set. In addition, the focus module receives reflecting information which is generated by the external device after the external device executes the focus function. The prompting module outputs different prompting information based on the received reflecting information.

### BACKGROUND

1. Technical Field

The present disclosure relates to a test device and a test method for testing focus function of an external device.

2. Description of Related Art

When a DVD player plays a disc, a light beam is emitted to the disc, and the light reflected beam is captured to read information recorded on the disc. A focus function of the DVD player is provided to test the emitted light beam and thus testing whether or not the DVD player can read the correct information from the disc. However, when testing the focus function of the DVD player, the user sometimes has to manually input a test instruction a number of times, which is complicated and time consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of a test device communicating with an external device in accordance with an embodiment.

FIG. 2 is a flowchart of a testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

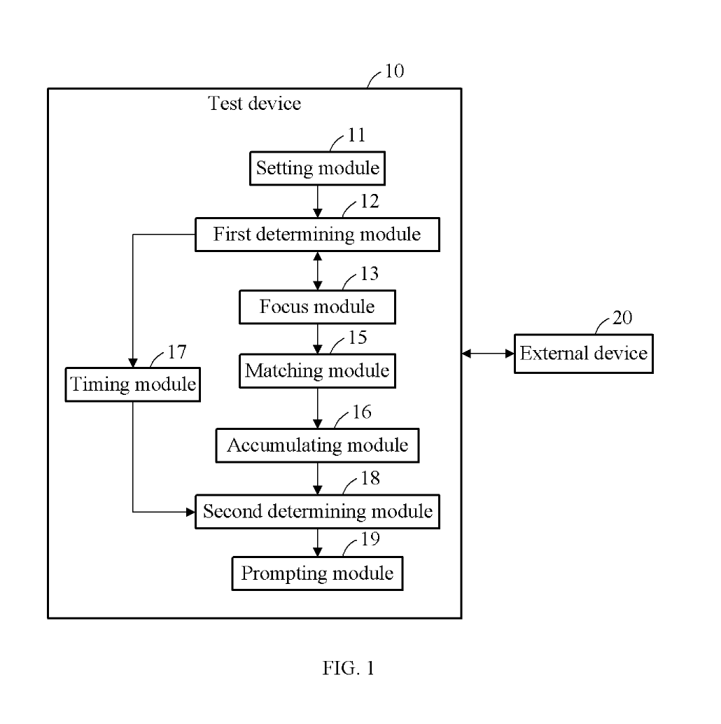

FIG. 1 shows a test device 10 of one embodiment of the present disclosure. The test device 10 communicates with an external device 20, which is capable of playing a disc (not shown) and automatically tests a focus function of the external device 20. The external device 20 includes a number of parameters in related to light beam emitted by the external device 20. In the embodiment, the test device 10 is a computer, and the external device 20 is a DVD player; the test device 10 connects with the external device 20 wirelessly. In other embodiments, the test device 10 connects with the external device 20 by wires.

The test device 10 includes a setting module 11, a first determining module 12, a focus module 13, a matching module 15, an accumulating module 16, a timing module 17, a second determining module 18, and a prompting module 19 which are a collection of software instructions.

The setting module 11 generates a setting signal and a checking signal in response to operations of a user. The setting signal is configured for controlling the external device 20 to set values of parameters in relation to the light beam emitted by the external device 20. In the embodiment, the parameters include, but not limited to, a swing range of a loader and a number of test times.

The first determining module 12 determines whether the test device 10 receives feedback information from the external device 20 in response to the checking signal. When the test device 10 receives feedback information from the external device 20, the first determining module 12 generates a trigger signal; when the test device 10 does not receive feedback information from the external device 20, the first determining module 12 generates a timing signal. In the embodiment, the feedback information indicates that the external device 20 has completely set the parameter based on the setting signal, and the feedback information is formatted in a predetermined character string and transmitted to the external device 20.

The focus module 13 generates a focus instruction for controlling the external device 20 to execute a focus function in response to the trigger signal, and receives reflect information from the external device 20 after executing the focus function.

The matching module 15 checks whether the received reflecting information matches standard information. When the received reflecting information matches the standard information, the matching module 15 generates a first control signal to indicate that a test of the focus function of the external device 20 is successful one time. When the received reflecting information does not match the standard information, the matching module 15 generates a second control signal to indicate that the test of the focus function of the external device 20 failed one time.

The accumulating module 16 accumulates the number of success times and generates a first determining signal in response to the first control signal. The accumulating module 16 further accumulates the number of failed times and generates a second determining signal in response to the second control signal.

The timing module 17 measures a duration of not receiving feedback information from the external device 20 and generates a third determining signal in response to the timing signal.

The second determining module 18 determines whether the success times exceed a first predetermined value in response to the first determining signal. When the success times exceed the first predetermined value, the second determining module 18 generates a first prompting signal. When the success times do not exceed the first predetermined value, the second determining module 18 generates a trigger signal. In the illustrated embodiment, the first predetermined value can be set by operations of the user.

The second determining module 18 further determines whether the failed times exceed a second predetermined value in response to the second determining signal. When the failed times exceed the second predetermined value, the second determining module 18 generates a second prompting signal. When the failed times do not exceed the second predetermined value, the second determining module 18 generates a trigger signal. In the embodiment, the second predetermined value can be set by operations of the user.

The second determining module 18 further determines whether the measured duration exceeds a predetermined period in response to the third determining signal. When the measured duration exceeds a predetermined period, the second determining module 18 generates a second prompting signal; when the measured duration does not exceed a predetermined period, the second determining module 18 generates the checking signal. In the embodiment, the predetermined period can be set by operations of the user.

The prompting module 19 outputs a first prompting information for indicating that the focus function of the external device 20 is in a normal state in response to the first prompting signal. In addition, the prompting module 19 outputs a second prompting information for indicating that the focus function of the external device 20 is in an abnormal state in response to the second prompting signal. In the embodiment, the first prompting information and the second prompting information can be video signal, audio signal, or text information for example.

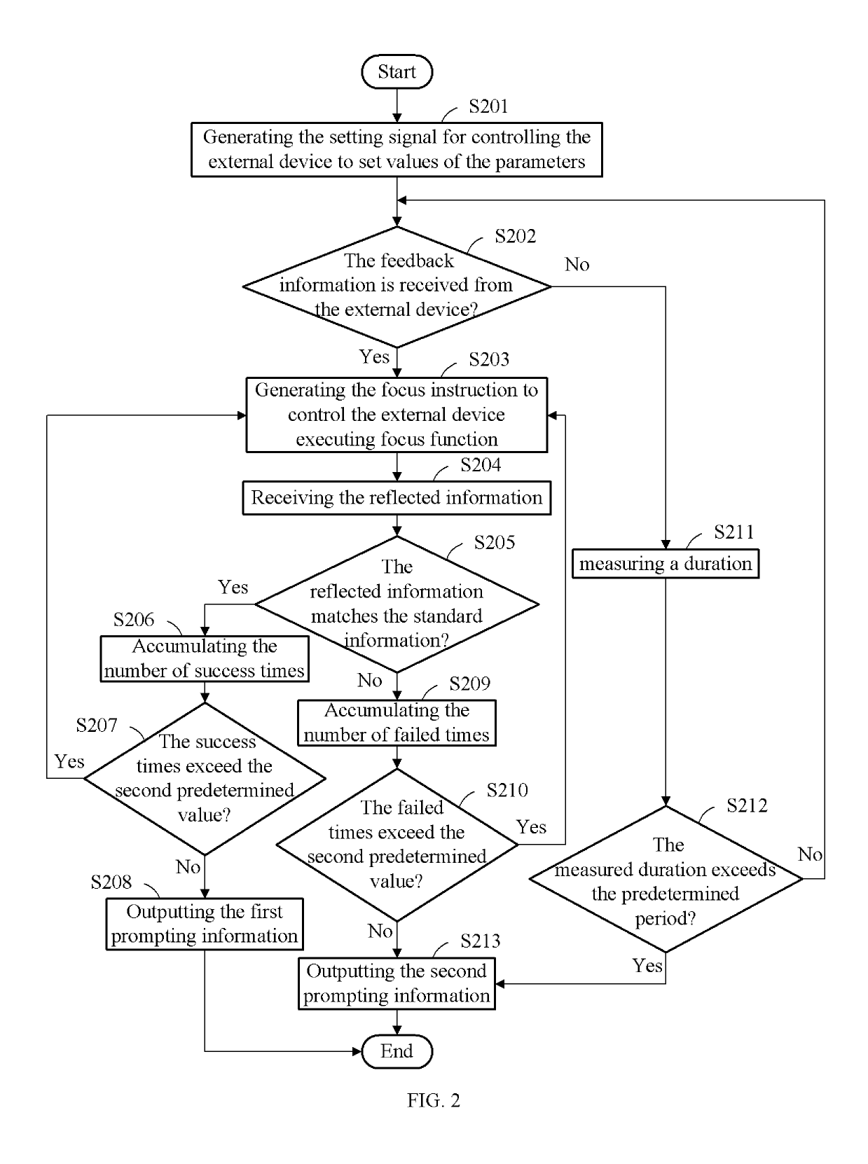

FIG. 2 shows a testing method for a test device 10 to automatically test focus function of an external device 20. The external device 20 for displaying a disc (not shown) 0 includes a number of parameters in related to light beam emitted by the external device 20. In the embodiment, the test device 10 is a computer, and the external device 20 is a DVD player; the test device 10 connects with an external device 20 wirelessly. The testing method includes the following steps.

In step S201, the setting module 11 generates a setting signal and a checking signal in response to an operation. The setting signal is configured for controlling the external device 20 to set values of parameters in relation to the light beam emitted by the external device 20. In the embodiment, the parameters include, but not limited to, a swing range of a loader and a number of test times.

In step S202, in response to the checking signal the first determining module 12 determines whether the test device 10 receives feedback information from the external device 20. If the test device 10 receives feedback information from the external device 20, a trigger signal is generated and the procedure goes to S203; if the test device 10 does not receive feedback information from the external device 20, a trigger signal is generated and the procedure goes to S211. In the embodiment, the feedback information indicates that the external device 20 has completely set the parameter based on the setting signal, and the feedback information is formatted in a predetermined character string and transmitted format the external device 20.

In step S203, in response to the trigger signal the focus module 13 generates a focus instruction for controlling the external device 20 to execute a focus function.

In step S204, the focus module 13 further receives reflect information from the external device 20 after the external device 20 executes the focus function.

In step S205, the matching module 15 checks whether the received reflecting information matches standard information. If the received reflecting information matches the standard information, a first control signal is generated for indicating that a test of the focus function of the external device 20 is successful one time and the procedure goes to S206. When the received reflecting information does not match the standard information, a second control signal is generated for indicating that the test of the focus function of the external device 20 failed one time and the procedure goes to S209.

In step S206, in response to the first control signal the accumulating module 16 accumulates a number of success times and generates a first determining signal.

In step 207, in response to the first determining signal the second determining module 18 determines whether the number of the success times exceeds a first predetermined value. If the success times exceed the second predetermined value, a first prompting signal is generated and the procedure goes to S208. If the success times do not exceed the first predetermined value, the trigger signal is generated and the procedure goes to S203.

In step S208, in response to the first prompting signal the prompting module 19 outputs a first prompting information for indicating that the focus function of the external device 20 is in a normal state.

In step S209, in response to the second control signal the accumulating module 16 accumulates a number of failed times and generates a second determining signal.

In step S210, in response to the second determining signal the second determining module 18 determines whether the number of the failed times exceeds a second predetermined value. If the failed times exceed the second predetermined value, a second prompting signal is generated and the procedure goes to S213. If the failed times do not exceed the second predetermined value, the trigger signal is generated and the procedure goes to S203.

In step S211, in response to the timing signal the timing module 17 measures a duration of not receiving feedback information and generates a third determining signal.

In step S212, in response to the third determining signal the second determining module 18 determines whether the measured duration exceeds a predetermined period. If the measured duration exceed the predetermined period, a second prompting signal is generated and the procedure goes to S213; if the measured duration does not exceed the predetermined period, the checking signal is generated and the procedure goes to S202.

In step S213, in response to the second prompting signal the prompting module 19 outputs a second prompting information for indicating that the focus function of the external device 20 is in an abnormal state.

In use, the test device 10 automatically generates focus instructions and tests the focus function of the external device 20 for times. Therefore, the testing operation is improved.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

1. A test device communicated with an external device with a plurality of parameters, the test device comprising:
at least one processor for executing computer programs of the test device;
a setting module, executed by the at least one processor, for generating a setting signal to control the external device to set values of the parameters in response to user's operation;
a first determining module, executed by the at least one processor, for determining whether the test device receives feedback information from the external device which are generated by the external device after the values of the parameters are completely set;
a focus module, executed by the at least one processor, for generating a focus instruction to the external device to control the external device to execute a focus function when the test device receives the feedback information from the external device, and receiving reflecting information which are generated by the external device after the external device executes the focus function; and
a prompting module, executing by the at least one processor, for generating different prompting information based on the received reflecting information.

2. The test device of claim 1, further comprising a matching module executing by the at least one processor, wherein the matching module determines whether the reflecting information matches standard information, when the reflecting information matches the standard information, the matching module controls the prompting module to output a first prompting information for indicating that the focus function of the external device is in a normal state; when the reflecting information does not match the standard information, the matching module controls the prompting module to output a second prompting information for indicating that the focus function of the external device is in an abnormal state.

3. The test device of claim 2, further comprising an accumulating module and a second determining module executed by the at least one processor, wherein the second determining module comprises a first predetermined value; when the reflecting information matches the standard information, the matching module controls the accumulating module to accumulate a number of success times for indicating that a test of the focus function of the external device is successful one time; the second determining module determines whether the success times exceeds the first predetermined value, when the success times exceeds the first predetermined value, the second determining module controls the prompting module generate the first prompting information.

4. The test device of claim 3, wherein the second determining module comprises a second predetermined value; when the reflecting information does not match requirements, the matching module controls the accumulating module accumulate a number of failed times for indicating that the test of the focus function of the external device failed one time; the second determining module determines whether the failed times exceeds the second predetermined value, when the failed times exceeds the second predetermined value, the second determining module controls the prompting module to generate the second prompting information.

5. The test device of claim 4, the first predetermined value and the second predetermined value can be set by operations of the user.

6. The test device of claim 1, further comprising a timing module and a second determining module executed by the at least one processor, wherein the second determining module comprises a predetermined period; when the test device does not receive the feedback information from the external device, the first determining module controls the timing module to measure a duration of not receiving feedback information from the external device; the second determining module determines whether the measured duration exceeds the predetermined period; when the measured duration exceeds the predetermined period, the second determining module controls the prompting module to generate the second information.

7. The test device of claim 6, wherein the predetermined period can be set by operations of the user.

8. The test device of claim 1, wherein the feedback information indicates that the external device has completely set the parameter based on the setting signal; the feedback information is formatted in a predetermined character string and transmitted format the external device.

9. A testing method for a test device to test focus function of an external device communicating with the test device; the external device comprising a plurality of parameters, the testing method comprising:
controlling the external device to set values of the parameters in response to a user's operation;
determining whether the test device receives the feedback information from the external device which are generated by the external device after the values of the parameters are completely set;
controlling the external device to execute a focus function to control the external device to execute a focus function when the test device receives the feedback information from the external device;
receiving reflecting information which are generated by the external device after the external device executes the focus function; and
outputting different prompting information based on the received reflecting information.

10. The method of claim 9, wherein the test device comprises a first predetermined value; after the step of processing the feedback data in the first format and displaying further comprising:
checking whether the reflecting information matches standard information;
accumulating a number of success times for indicating that a test of the focus function of the external device is successful one time when the reflecting information matches the standard information;
determining whether success times exceeds the first predetermined value; and
outputting a first prompting information when the success times exceed the first predetermined value for indicating that the focus function of the external device is in a normal state.

11. The method of claim 10, wherein the first predetermine value can be set by operations of the user.

12. The method of claim 10, wherein the test device further comprises a second predetermined value; the step of determining whether the reflecting information matches requirements further comprising:
accumulating a number of failed times for indicating that the test of the focus function of the external device failed one time when the reflecting information does not match the standard information;
determining whether failed times exceeds the second predetermined value; and
outputting a second prompting information when the failed times exceed the second predetermined value for indicating that the focus function of the external device is in an abnormal state.

13. The method of claim 12, wherein the second predetermine value can be set by operations of the user.

14. The method of claim 9, wherein the test device further comprises a predetermined period; the step of determining whether the test device receives the feedback information from the external device further comprising:
measuring a duration when not receiving the feedback information from the external device;
determining whether the measured duration exceeds the predetermined period; and
outputting a second prompting information when the measured duration exceeds the predetermined period for indicating that the focus function of the external device is in an abnormal state.

15. The method of claim 14, wherein the predetermined period can be set by operations of the user.

16. The method of claim 9, wherein the feedback information indicates that the external device has completely set the parameter based on the setting signal; the feedback information is formatted in a predetermined character string and transmitted format the external device.

17. A test device communicated with an external device with a plurality of parameters, the test device comprising:
at least one processor for executing computer programs of the test device;
a setting module, executed by the at least one processor, for generating a setting signal to control the external device to set values of the parameters in response to user's operation;
a first determining module, executed by the at least one processor, for determining whether the test device receives feedback information from the external device which are generated by the external device after the values of the parameters are completely set;
a focus module, executed by the at least one processor, for generating a focus instruction to the external device to control the external device to execute a focus function when the test device receives the feedback information from the external device, and receiving reflecting information which are generated by the external device after the external device executes the focus function; and
a prompting module, executing by the at least one processor, for generating different prompting information based on the received reflecting information;
wherein the feedback information indicates that the external device has completely set the parameter based on the setting signal; the feedback information is formatted in a predetermined character string and transmitted format the external device.

18. The test device of claim 17, further comprising a matching module, an accumulating module, and a second determining module which are executed by the at least one processor, wherein the second determining module comprises a first predetermined value; the matching module determines whether the reflecting information matches standard information, when the reflecting information matches the standard information, the matching module controls the accumulating module to accumulate a number of success times for indicating that a test of the focus function of the external device is successful one time; the second determining module determines whether the success times exceeds the first predetermined value, when the success times exceeds the first predetermined value, the second determining module controls the prompting module generate a first prompting information.

19. The test device of claim 18, wherein the second determining module comprises a second predetermined value; when the reflecting information does not match requirements, the matching module controls the accumulating module accumulate a number of failed times for indicating that the test of the focus function of the external device failed one time; the second determining module determines whether the failed times exceeds the second predetermined value, when the failed times exceeds the second predetermined value, the second determining module controls the prompting module to generate a second prompting information.

20. The test device of claim 17, further comprising a timing module and a second determining module executed by the at least one processor, wherein the second determining module comprises a predetermined period; when the test device does not receive the feedback information from the external device, the first determining module controls the timing module to measure a duration of not receiving feedback information from the external device; the second determining module determines whether the measured duration exceeds the predetermined period; when the measured duration exceeds the predetermined period, the second determining module controls the prompting module to generate the second information.
